(19) United States
(12) Patent Application Publication
(10) Pub. No.: US 2010/0288562 A1
(43) Pub. Date: Nov. 18, 2010

(54) NOZZLE WITH CHANNELS THAT IMPART AN ANGULAR MOMENTUM TO THE EXITING FLUID AND METHODS FOR MAKING AND USING SAME

(75) Inventors: Norval Roland Dove, Houston, TX (US); John E. Akin, Houston, TX (US)

Correspondence Address: ROBERT W STROZIER, P.L.L.C, PO BOX 429, BELLAIRE, TX, 77402-0429, US

(73) Assignee: VORTEXX GROUP, INC., Houston, TX (US)

(21) Appl. No.: 12/227,660

(22) PCT Filed: Feb. 28, 2007
(86) PCT No.: PCT/US2007/005174

§ 371 Date: Nov. 13, 2009

Related U.S. Application Data
(60) Provisional application No. 60/777,639, filed on Feb. 28, 2006.

(51) Int. Cl. E21B 10/18; B05B 1/00; F02B 3/12; B67D 7/00

(52) U.S. Cl. 175/340; 222/566; 123/299; 222/1

(57) ABSTRACT

Novel nozzles are disclosed that include flutes and/or baffles having cross-sections that undergo a rotation from a nozzle inlet to a nozzle outlet to produce fluid flows having a velocity profile including both linear and angular velocity components.

### RELATED APPLICATIONS

This application claims priority to U.S. Provisional Patent Ser. No. 60/777639, filed 28 Feb. 2006.

### BACKGROUND OF THE INVENTION

1. Field of the Invention

The present invention relates to nozzles that produce a fluid flow having a pre-set and/or adjustable linear velocity or momentum and a pre-set and/or adjustable angular velocity or momentum, where the linear and angular velocity are adapted to improve characteristics of fluid dynamics as the fluid exits the nozzles. The present invention also relates to apparatuses including the nozzles and to methods for making and using the nozzles and/or apparatuses.

More particularly, the present invention relates to nozzles that produce a fluid flow having a linear velocity or momentum and an angular velocity or momentum, where the velocities can be pre-set or adjustable and where the nozzles have one flute or a plurality of flutes having cross-sections that rotate over a portion of the interior or from an inlet to an outlet or have one baffle or a plurality of baffles having cross-sections that rotate or twist from an inlet to an outlet, i.e., the zone from the inlet to the outlet imparts linear and angular velocities to the fluid passing through the zone. The present invention also relates to apparatuses including the nozzles and to methods for making and using the nozzles and/or apparatuses.

2. Description of the Related Art

Rotary drill bits are used in drilling deep holes such as oil and/or gas wells. Some bits are polycrystalline diamond compact (“PDC”) bits with segmented rows or sectors of diamond hardened cutters; other bits are rotary cone bits. Still other drill bits can be natural diamond, rock bits, under-reamers and coring tools. The rotary cone bits have a plurality of rotating toothed conical cutters with vertices directed toward the centerline of the drill bit. The conical cutters are rotatively borne upon cantilevered journal shafts, which extend from the lower periphery of the bit body angularly downward and radially inward relative to the centerline of the vertically cylindrical bit body. In each bit, the bit body upper end is threaded for attachment to the lower end of a drill line made of pipe. In normal drilling operations, the drill line pipe is rotated while forcing the rock bit into the earth. The sectors of teeth in a PDC bit or the cones in a rotary cone bit travel about the centerline of the drill bit and the rock cutters dig into the geologic formation to fail scrape, crush and/or fracture it.

The bit body also serves the function of a terminal pipe fitting to control and route a drilling fluid flow from inside the drill line pipe out through a plurality of mud nozzles housed in the drill bit and up the annulus between the drill column and the well bore. The drilling fluid accomplishes a number of critically important tasks, the foremost of which is preventing formation fluids from entering the well bore and causing a blowout. Drilling fluids (“muds”) are weighted to provide a hydrostatic pressure in the well bore at any given depth that at least equals the formation pressure at the particular depth. Mud weights are usually controlled by adding a high density material such as barite to the mud. Drilling muds are thixotropic fluids that have high viscosity's at low shear rates and low viscosity's at high shear rates. At the high shear rates in bit nozzles, the mud has plastic flow characteristics approaching Newtonian behavior, like water. Jetted from the bit nozzles, it is employed to dissipate the heat of drilling and to flush cuttings from the drilling zone. At the lower shear rates in the annulus between the well bore wall and the drill line pipe, the viscosity increases and is sufficient to buoy cuttings upward to the surface for filtering from the mud. Vertical channels, sometimes called “junk slots, are formed between the exterior wall of the rock bit body adjacent the nozzle locations and the bore hole wall to facilitate the flow of fluid and entrained cuttings from the drilling zone.

Cuttings removal is critically important to the rate of penetration of the drilled formation, for control of viscosity of the drilling fluid, and to minimize wear and tear on drilling rig mud circulation apparatus. Inadequate removal of cuttings from the interface between the cutters teeth of the drill bit and the formation rock causes the more substantial rock chips on the hole bottom to be ground to a paste by the bit. For example, a cube of particle 200 microns on each side, if allowed to remain in the bore hole, could be ground into eight million one micron cubes. These cuttings, called “drilled solids,” approach colloidal size and hydrate in the fluid, increasing fluid viscosity at the bit (“plastic viscosity”). As plastic viscosity of the mud increases, drilling rate decreases. This is because the mud must get under a chip quickly so the bit cutters do not grind the chip instead of formation rock. If viscosity is high, the fluid cannot get under the chip rapidly and efficiently flush cuttings from the hole bottom. This impedes the penetration of the rock bit into the geological formation, abrasively wears the cutters of the rock cutters, causes excessive drag, and can produce well bore damage. If the drilled solids are left in the mud, the viscosity of the mud in the annulus increases and can make thick filter cakes that reduce the area for moving mud up the annulus. This can lead to lost circulation and formation damage and to stuck drill pipe.

Nozzles are also used in engines having fuel injection systems. Nozzles are also used in hydraulic or pneumatic cutters or pulverizers or other fluid cutting or fracturing apparatuses. In all these other applications, the effectiveness and efficiency of the fluid dynamics of the fluid impacting the surface to which it is being directed and benefit from improved fluid dynamics.

Although nozzles are now available for producing fluids flows that can fracture surfaces in drilling application, can cut surfaces, can pulverize materials, or can produce fluid flows having improved combustion characteristics, there is a need in the art for improved nozzles and apparatus including such nozzles, where the nozzles having new geometries for fluid flow patterns that have a velocity profile including linear and angular momentum components.

### SUMMARY OF THE INVENTION

The present invention provides nozzles having a zone in a fluid path between a inlet and an outlet, where the zone has a structure or includes structures that produce a fluid flow having both linear and an angular momenta or velocities. Fluid flows having both linear and an angular momenta or velocities have improved cutting, cleaning, mixing, and/or other dynamic characteristics. The structures form an interior having a cross-section profile that when rotated relative to an axis extending a length of the interior imparts the angular momentum to the fluid passing through the nozzle. Of course, the interior cross-sectional profile cannot be purely circular as rotation of such a profile would not impart an angular momentum to the fluid passing through it. Thus, the profile must have a structural feature or a plurality of structure features that undergo a twist or rotation down all or a portion of the length of the interior. The contour of the twisted structure features can be continuous or discontinuous provided that the length of twisted profiled interior is sufficient to impart the desired angular momentum to a fluid passing through the nozzle. The features define spiral contours that can be continuous of discontinuous, provided that the length of the contours are sufficient to impart the desired angular momentum to a fluid passing through the nozzle.

The present invention provides nozzles having a zone in a fluid path between a inlet and an outlet, where the zone has a structure or includes structures that produce a fluid flow having a controllable hydrostatic pressure profile including cross-sectional positive and negative hydrostatic pressure regions and linear and an angular momenta or velocities. Fluid flows having cross-sectional differential pressure profiles and linear and an angular momenta or velocities have improved cutting, cleaning, mixing, and/or other dynamic characteristics. Apparatuses including nozzles of this invention can include a mixture of nozzles some that do not produce jets having angular velocity, some that produce jets with angular momentum, but do not produce jets with a differential, cross-sectional pressure profile and some that produce both angular momentum and a differential, cross-sectional pressure profile, depending on the desired overall all profile desired.

In drill bits including nozzles of this invention, the nozzles has improved cleaning action of the fluid jets at the rock cutter interface. If the bit has a plurality of such nozzles, then the angular component of the fluid momentum of the fluid jets from each of the nozzles can be adjusted to maximize, change, alter or minimize flow characteristics of the combined fluid flow. That is the angular momentum of each nozzle can be the same or different and if the nozzles are constructed to produce differential, cross-sectional hydrostatic pressure profiles, the profiles can be the same or different. Moreover, the bits can includes a combination of nozzles that produce fluid jets having linear and angular momenta or velocities and nozzles that produce differential, cross-sectional hydrostatic pressure profiles. Additionally, certain nozzles can be constructed with adjustable flights or other elements to permit instantaneous alterations of the linear and/or angular flow characteristics produced by each nozzle so that the flow patterns in and around the nozzles and bits can be changes on the fly.

The present invention provides nozzles for drilling bits to produce impinging jets to maximize the rate of penetration of a drill bit, to eliminate hydrostatic hold down forces, to sweep cuttings and formation fragments into the annulus, and to minimize a major source of escalating viscosity in the drilling mud, where the jets are designed or adapted to produce a fluid flow having a controlled or controllable, cross-sectional, differential hydrostatic pressure profile including positive and negative hydrostatic pressure regions at the rock cutter interface and having both a linear and an angular momenta or velocities, which produces an improved cleaning action of the jets at the rock cutter interface. If the bit has a plurality of such nozzles, then the angular component of the fluid momentum of the flows from each of the nozzles can be adjusted to maximize, change, alter or minimize flow characteristics of the combined fluid flow. That is the angular momentum of each nozzle can be the same or different. Additionally, certain nozzles can be constructed with adjustable flights or other elements to permit instantaneous alterations of the linear and/or angular flow characteristics produced by each nozzle so that the flow patterns in and around the nozzles and bits can be changes on the fly.

The present invention provides nozzles are designed to produce a fluid flow that creates and locates one or more zones of comparatively negative hydrostatic pressures at the interface of the rock bit cutter cone and the formation rock at the very bottom of the well bore and imparts an angular momentum component to the zones so that the zones spin improving the cleaning of the bottom of the well. This rock formation-cutter interface represents an insignificant volumetric fraction of the well bore and by reducing the hydrostatic pressure at this localized interface below the threshold of the formation pressure at the depth of the hole bottom, and at no other point in the well bore, the strata at the interface is made to explode with violent force into the well bore below the rock cutter, easing and accelerating the rock cutter. The present invention also creates vortex shedding due to the angular momentum components, which introduce turbulent fluctuating pressure within both high and low pressure regions which assist in sweeping cuttings to the periphery of the rock cutter and into the annulus for circulation from the well bore. Changes in drilling fluid flow rate alter the negative hydrostatic pressure values, without change in regime apex focus. Of course, changes in drilling fluid flow rate does alter the amount of angular velocity imparted to the fluid flow.

The present invention also provides a method of removing a surface subject to a subsurface pressure and an environmental surface pressure at least equal to the subsurface pressure, where the method includes the step of jetting fluid through a nozzle facing and located a predetermined distance from the surface. The nozzle is shaped to eject the fluid in a stream having a higher core pressure than the environmental pressure, and the higher pressure stream has adjacent thereto at least one zone of pressure less than subsurface pressure, a negative pressure zone. The distance from the surface is predetermined to expose the surface to the zone of negative pressure, such that the surface is caused to explode into the zone of negative pressure from the force of the subsurface pressure. Moreover, because the nozzle is designed to impart not only a linear velocity, but an angular velocity as well, the nozzle design further enhances both impinging and non-impinging fluid flows from the nozzle by increasing the HHP. The angular velocity also causes the negative pressure zones to spin at a desired rate increasing sweeping motion and increasing the surface being exposed to the negative pressure zones over time.

The present invention also provides a method including the steps (a) rotating a drill bit in an earth formation to form a bore hole. The drilling bit comprises a housing forming an exterior shell having a pin end and rock cutter end, the pin end being connected to a tubular drill string fluidly connected to a drilling fluid supply. The housing includes an inlet at the pin end and an interior cavity extending from the inlet to at least one nozzle in the rock cutter end. The nozzles include a passageway fluidly communicating with the cavity and converging to an outlet at the rock cutter end. At least one of the outlets includes a slot configuration therein extending to at least a portion of the passageway convergence. The rock cutter end are designed to cut formation at hole bottom. The method also includes the step of (b) pumping drilling fluid down the drill sting through the cavity, and under turbulent flow conditions through the passageway convergence and the slot configuration out the outlet into the hole bottom into an environment having a hydrostatic pressure at least equal to formation pressure at the drilling depth of the hole bottom. The ejected fluid emerging as a zone of higher hydrostatic pressure than the environmental hole bottom hydrostatic pressure and having adjacent thereto at least one zone of hydrostatic pressure negative relative to the formation hydrostatic pressure, i.e., having a pressure less than the formation hydrostatic pressure. Because the slot is constructed with a desired twist angle, the ejected fluid not only has a desired linear momentum and cross-sectional, differential pressure profile, but also has a desired angular momentum. The angular momentum component causes the negative and positive hydrostatic pressure zones to rotate about the linear jet direction increasing the sweeping action of the fluid to push debris into the annulus and increasing the amount of surface exposed to the negative and positive pressure zones. The method also includes the step of (c) impinging the rotating negative hydrostatic pressure zones at the interface of hole bottom rock surface and rock cutter, thereby exploding rock surface into the well bore between the rock cutter end and hole bottom, while sweeping the cuttings free. The zone of higher hydrostatic pressure peripherally degrades from a maximum positive value in a core portion thereof, and the zone of negative hydrostatic pressure peripherally degrades from a maximum negative value in a core portion thereof. The core portion of the negative zone is spaced essentially equidistant from adjacent extremities of the core portion of the higher pressure zone. The angular momentum cause the entire negative and positive zone profile to change in a rotatory fashion.

The present invention also provides a nozzle including a body having first end and second ends. The first end includes means for connecting the nozzle to a fluid supply. The nozzle may be one in which a connection is into a drill bit in fluid communication with a fluid supply of drilling fluid. The nozzles may be feeding cylinders of an internal combustion engine and connected to a fuel supply. The nozzles may be directing a cutting fluid at a surface and connected to a cutting fluid supply. The body has an inlet at the first end and an interior cavity. The cavity extends from the inlet and converges to an outlet or a plurality of outlets at the second end. The outlet includes at least one slot extending to the cavity. The cavity convergence and the slot configurations are effective, when fluid is forced therethrough under turbulent flow conditions into a fluid environment having a positive hydrostatic pressure, to eject the fluid in a fluid profiles having a zone of hydrostatic pressure higher than the environmental hydrostatic pressure adjacent a zone of hydrostatic pressure lower than the environmental hydrostatic pressure, thereby resulting in attendant turbulent pressure fluctuations and vortex shedding. In certain embodiments, the cavity convergence is frustoconical. In other embodiments, the convergence is at an angle that intersects the axis of the outlet portion exteriorly of the outlet. The slots are suitably plane perpendicular to the axis of the outlet, and is linear or curvilinear, but not circular. The convergence of the slot from the second end to the cavity undergoes a twist so that the fluid attains a desired degree of angular momentum so that the fluid profile rotates in the direction of the twist, which can be clockwise or counter-clockwise depending on a twist angle being negative or positive.

The present invention also provides a nozzle including a body having a longitudinal axis and defining an interior passageway along the longitudinal axis. The passageway includes an inlet at a first end of the body, a frustoconical portion distal from the inlet and a slot portion distal from the inlet conterminously with the frustoconical portion. The slot portion terminates in an outlet and the slot has a profile representing a cross-sectional view of the frustoconical portion formed by a plane perpendicular to the longitudinal axis at the outlet.

In the improved nozzle, an interior flute(s) leading to the outlet is generally spiraled about the longitudinal axis of the interior passageway, and increases the flute(s) cross-sectional area(s) at selected interior positions along the longitudinal axis. In some applications, the increased flute cross-section is reduced to zero at the outlet.

The invention generally provides a nozzle jet that transitions from an inlet shape to an offset outlet shape with a transition surface designed with different angles of transition so that a profile of a fluid jet impinging on a perpendicular plane includes regions of significant negative pressure on or near the plane. The negative pressure regions are a phenomena contrasted to symmetric nozzles that produce only positive pressure of a fluid jet on the impingement plane. The asymmetric jets of the present invention have negative toroidal pressure cells that lie above the perpendicular plane. Moreover, because the transition surfaces includes a twist, a vector perpendicular to an interior surface of the inlet undergoes either a clockwise or counterclockwise rotation at the outlet. Thus, the fluid jet not only includes a profile including negative and positive pressure regions, but also includes angular component which causes the profile to rotate about an axis perpendicular to the nozzle end having the outlet. The rotation rate of the profile is controlled by a length of a twisted portion of the transition zone and by the magnitude of the clockwise or counterclockwise rotation. Each of these parameters is independently controlled. The rate of rotation of the profile is also dependent on the linear velocity of the fluid being pumped through the nozzle. Thus, the exiting fluid jet not only includes a linear velocity having a profile including relatively positive and negative pressure regions, but an angular velocity sufficient to cause the profile to rotate at come desired rate. In certain embodiments, where the fluid flow is desired to have a more constant pressure profile, but linear and angular velocity components, then the interior can simply include a structure that impart either a clockwise or counterclockwise angular component to the fluid flow.

The present design produces the phenomena through the choice of the interior transition surface angles so that selected potions of the negative pressure cells are forced to lie on the impingement surface. For non-impinging flows, the interior fluid transitions position the cells downstream from the outlet at a distance of several (about XX) inlet diameters. Transition angles can cause significant turbulence and control the location of the turbulence and negative pressure regions. Articles near the impingement surface are pulled upward and into the fluid.

In a drill bit application, either integrally formed there into or incorporated as an insert there into, the invention provides a drilling bit comprising a housing forming an exterior shell having a pin end and rock face end. The pin end includes a connector to place the pin end into fluid communication with a fluid supply. The housing has an inlet at the pin end and an interior cavity extending from the inlet to at least one nozzle in the rock face end. The nozzles include a passageway in fluid communication with the cavity and converging to an outlet at the rock face end. At least one of the nozzle outlets has a slot configuration therein extending to at least a portion of the passageway convergence. The passageway convergence and the slot configuration are effective, when fluid is forced therethrough under turbulent flow conditions into a fluid environment having a positive hydrostatic pressure, to eject the fluid in a perpendicular profile having a zone having a hydrostatic pressure higher than an environmental hydrostatic pressure and an adjacent zone having a hydrostatic pressure lower than the environmental hydrostatic pressure.

Besides the use of the nozzles of this invention in drilling applications, the nozzles of this invention will also find applications, where the turbulence and distorted negative pressure cells are used for improving mixing of compressible and incompressible media. These other applications include fuel injection nozzles for internal combustion engines; fuel injection nozzles for coal and water injection into power plant furnaces; sand/water blasting nozzles; fluid cutters; analytical instruments injector systems; nebulizer or atomizer nozzles; pneumatic and hydraulic pulverizing systems; and medical mixing applications. In addition, the nozzles of this invention may find enhanced utility in these non-impinging flow applications due to the fact that the pressure profile rotates, i.e., the ejected fluid has both a linear and angular component which causes the fluid profile to rotate and if the pressure profile has a differential pressure profile, then that profiles rotates as well. Rotating profiles of relative constant pressure profiles and rotating profiles having negative and positive pressure zones (differential pressure profiles) result in enhanced cutting of surfaces, pulverizing of surfaces, cleaning of surfaces and increased mixing and removal of dead zones.

The current invention provides nozzles where the transitional flute region is twisted or spiraled or otherwise configured so that the exiting fluid has an angular velocity component as well as a linear velocity component so that the fluid profile rotates as it propagates out of the nozzle. Thus, the interior includes flutes in a spiral, twisted or rotated fashion or construction, about an axis generally centered between the centroid points of the entrance and exit areas. This flute shape imparts the angular momentum of the exiting fluid. In addition, it causes shear stresses in the plane of the exit area thereby additionally contributing to the hydraulic horsepower (HHP) imparted to the fluid.

The invention provides improved eroding, cleaning and mixing capabilities of a fluid flow. Greater levels of erosion, cleaning and mixing are achieved for the expended energy, and thus more efficient fluid flow is produced. Eroding and cleaning capabilities are enhanced, in part, because the invention produces a fluid flow having linear and angular velocities and optionally a profile including a pressure maximum and a pressure minimum (e.g., a strong positive pressure and a strong negative pressure) at substantially the same axial distance from the source of the flow. Mixing capabilities are increased as a result of increased turbulent kinetic energy throughout the flow region and due to the angular spin of the fluid cross-section profile. The invention may also produce a region of rotating turbulent kinetic energy at substantially the same axial distance from the source of the maximum and minimum pressure regions. The invention may calibrate, or focus, fluid flow to provide minima and maxima in set locations. The angular component of the fluid flow causing the maxima and minima to rotate about the fluid flow direction. This rotating of the profile further improves eroding, cleaning and mixing characteristics of the fluid flow.

The invention has utility in conjunction with an impingement surface. Fluid contacts the impingement surface in a manner that produces a rotating fluid profile. In certain embodiments, the fluid contacts the impingement surface in a manner that produces a rotating fluid profile having regions of positive and negative pressure at the surface. In addition, the fluid flow creates a region of spinning turbulence which lies at the surface. As a result, the fluid flow not only imparts pressure to the impingement surface, but also a spinning pressure that pulls material away from the surface. The fluid flow also enhances the effects of turbulence away from the impingement surface. In Moreover, because the positive and negative pressure zone are rotating due to the angular component of the fluid motion, the fluid flow tends to better clean the surface and tends to further decrease dead spots or relatively unmixed fluid regions.

In general, in one aspect of the invention, a method of conditioning a flow of fluid includes the steps of introducing a fluid into a nozzle body, directing the fluid introduced into the nozzle body over an inner surface of the nozzle body, and applying a pressure to the fluid. The nozzle body has an opening defining an inlet and an opening defining an outlet. The inner surface of the nozzle body connects the inlet to the outlet and in certain embodiments is eccentric throughout its longitudinal dimension. For embodiments have an eccentric inner surface, applying pressure to the fluid provides a first region outside the nozzle of relative maximum pressure and a second region outside the nozzle of relative minimum pressure, where the first and second regions are substantially the same distance from the outlet. Whether the inner surface is eccentric or not, the inner surface also includes a twist, rotation or spiral component so that the fluid exists the outlet with an angular momentum component. If the inner surface is eccentric, then the twist component causes the first region outside the nozzle of relative maximum pressure and the second region outside the nozzle of relative minimum pressure to rotate. If the inner surface is non-eccentric, then the twist component causes the pressure profile to rotate.

Embodiments of the invention include the following features. The step of directing the fluid may comprise focusing the fluid such that the first region of relative maximum pressure and the second region of relative minimum pressure occur at a predetermined distance. The step of introducing a fluid into a nozzle body includes the additional steps of forming an axisymmetric inlet and forming an asymmetric outlet. The outlet may also be circular. The step of introducing a fluid may also include the step of forming an outlet which is symmetric-periodic or N-lobe periodic in shape, as well as the step of forming a circular inlet. The method of conditioning a flow of fluid may further include the step of directing the conditioned fluid against an impingement surface to provide a negative pressure thereon. The step of introducing a fluid into a nozzle body may comprise introducing liquid into the nozzle body or introducing gas into the nozzle body. This step also may comprise introducing a multi-phase flow into the nozzle body or introducing a particulate material into the fluid. The step may also include of directly the fluid through a spiraled transition zone designed to impart an angular momentum component to the existing fluid.

In general, in another aspect of the invention, a fluid-conditioning nozzle comprises an inlet having an edge defining a first circumference, an outlet having an edge defining a second circumference, and a transition surface extending between the inlet and the outlet. The second circumference is smaller than the first circumference and the outlet is offset from and spaced apart from the inlet. The transition surface is eccentric throughout its longitudinal dimension between the first and second circumferences, and the nozzle is operable to provide a first region outside the nozzle of relative maximum pressure and a second region outside the nozzle of relative minimum pressure, where the first and second regions are substantially the same distance from the outlet. The transition surface also spiraled so that the fluid acquires an angular momentum component as the fluid traverse the transition zone and exists from the outlet to form a fluid flow profile including relative positive and negative pressures that rotates about its propagation direction.

Embodiments of the invention include the following features. The inlet, the outlet, and the transition surface may be focused such that the first region of relative maximum pressure and the second region of relative minimum pressure occur at a predetermined distance. The outlet may be symmetric-periodic or N-lobe periodic in shape, and the inlet may be substantially circular in shape. The inlet and the outlet both may be substantially circular or substantially elliptical in shape. The transition surface may be linear or may curve between the first and second circumferences. The transition surface may also have a different slope at diametrically opposed locations at the circumference of the outlet. The nozzle may comprise cast metal or molded plastic. The transition zone also includes a spiral component designed to impart a desired amount of angular momentum to the fluid flow so that the fluid static profile rotates at a desired rate upon exiting the nozzle.

In general, in another aspect of the invention, a fluid-conditioning nozzle comprises a substantially circular inlet having a first radius R₁ and a first centerline, a substantially circular outlet having a second radius R₂ and a second centerline, and a transition surface extending between the inlet and the outlet. The second radius R₂ is smaller than the first radius R₁. The second centerline is parallel to the first centerline, and the first and second center lines are offset a radial distance d from each other. The inlet and the outlet are spaced apart in axial distance L from each other. The transition surface has a longitudinal cross-section defining a first edge with a first slope A₁ and a second edge with a second slope A₂, where the first edge and the second edge are at diametrically opposed locations on the transition surface. The first slope A₁ and the second slope A₂ are defined by the equation:

tanA₁+tanA₂=(2R₁−2R₂)/L.

The radial distance d is defined by the equation:

d=R₁−R₂−L(tanA₂).

The inlet, the outlet and the transition surface are co-operable to provide a first region outside the nozzle of relative maximum pressure and a second region outside the nozzle of relative minimum pressure, where the first and second regions are substantially the same distance from the outlet. In specific embodiments of the invention, the first and second cross-sectional edges may be either linear or curved.

In general, in another aspect of the invention, a method of manufacturing a nozzle comprises the steps of forming an inlet and an outlet in a nozzle body, the inlet and the outlet being eccentric, joining the inlet and the outlet with a transition surface having an edge of first perimeter at a first end in contact with the inlet and having an edge of second perimeter at a second end in contact with the outlet, and tapering the transition surface through the nozzle body such that the second edge perimeter is smaller than the first edge perimeter. The inlet, the outlet and the transition surface cooperate to define a fluid passage through the nozzle body, and the nozzle is operable to provide a first region outside the nozzle of relative maximum pressure and a second region outside the nozzle of relative minimum pressure, where the first and second regions are substantially the same distance from the outlet. In specific embodiments of the invention, the step of tapering the transition surface may comprise forming either a linear surface or a curved surface through the nozzle body, and the inlet and the outlet may be either substantially circular, substantially elliptical, or periodic in shape.

U.S. Pat. No. 5,785,258 (a continuation in part of U.S. Pat. No. 5,494,124) teach using the same nozzle interior geometry to provide a first region outside the nozzle of relative maximum pressure and a second region outside the nozzle of relative minimum pressure, where the first and second regions are substantially the same distance from the outlet. U.S. Pat. Nos. 5,785,258 and 5,494,124 are incorporated therein by reference.

Later theoretical studies of these nozzle flows identified that in addition to creating flow regions of negative pressure they increase the hydraulic horse power that the nozzle imparts to the fluid and thus to the impinged surface. This is very desirable for fracturing the surface and for the efficient removal of cuttings from the bore hole bottom. The current invention teaches new geometry for negative pressure nozzles that also further increase the hydraulic horsepower and angular momentum of the exiting fluid.

The current invention teaches the twisting of the transitional flute regions of the interior in a spiral or rotational fashion, about an axis generally centered between the centroid points of the entrance and exit areas, where the twist is adapted to impart a desired angular velocity of the fluid flow. In addition, it causes shear stresses in the plane of the exit area thereby additionally contributing to the hydraulic horsepower imparted to the fluid.

The present invention also provide a cutting apparatus including a cutting head having at least one nozzle of this invention so that the fluid exiting the nozzle has both linear and angular velocities and optionally a differential, cross-sectional pressure profile. The cutting apparatus can either produce a constant fluid flow or can be pulsed to produce short bursts of rotating fluid packets. The fluid can be gas or liquid depending on the cutting being performed. Thus, for pneumatic cutting or pulverizing apparatuses, the nozzles are adapted to produce a gas flow having angular and linear velocities. For hydraulic cutting apparatus such as pulsed water cutting apparatuses, the nozzles are adapted to produce continuous or pulsed fluid jets having angular and linear velocities. In both embodiments, the jets can also include a cross-sectional, differential pressure profile including relative negative pressure regions and relative positive pressure regions.

### BRIEF DESCRIPTION OF THE DRAWINGS

The invention can be better understood with reference to the following detailed description together with the appended illustrative drawings in which like elements are numbered the same:

FIGS. 1A-P depict various views of different prior art nozzles;

FIGS. 2A-L depict various views of an embodiment of nozzles of this invention having two flutes in an opposing configuration;

FIGS. 3A-M various views of another embodiment of nozzles of this invention having three flutes in a propeller configuration;

FIGS. 4A-M various views of another embodiment of nozzles of this invention having two flutes in a facing configuration;

FIGS. 5A-D various views of an embodiment of nozzle body of flute structure of FIGS. 4A-M;

FIGS. 6A-D various views of another embodiment of nozzles of this invention having a two flutes in an opposing configuration having concave transition surfaces;

FIGS. 7A-D various views of an embodiment of nozzles of this invention having two flutes in an opposing configuration having convex transition surfaces;

FIGS. 8A-D various views of an embodiment of nozzles of this invention having a single flute;

FIGS. 9A-C depict nozzle embodiments having one flute, three flutes and four flutes that undergo different degrees of rotation from an inlet to an outlet; and

FIGS. 10A-C depict nozzle embodiments having baffles that undergo different degrees of rotation from an inlet to an outlet.

### DETAILED DESCRIPTION OF THE INVENTION

The inventors have found that nozzles can be constructed for producing fluid flow having velocity profiles including linear and angular velocity components. Moreover, the inventors have found that the nozzles can be constructed with flutes having transition surfaces and/or baffles to produce positive and negative pressure zones in the fluid flow exiting the nozzles so that the positive and negative pressure profile rotate at a rate defined by the pressure of the fluid entering the nozzle inlet, the rotation angle of the flutes and/or baffles and the shape of the transition surfaces or baffles.

A person of ordinary skill in the art will recognize that nozzles to not have to be removable from its surrounding body. That is, the nozzle geometry can be built into the body by casting or machining. For large nozzles a casting or rapid prototype construction may suffice, while very small nozzles might be formed by EDM (Electric Discharge Machining), pulsed laser machining, or other methods.

An example of such nozzles in drilling applications is the pneumatic hammer drill (PHD) that is employed in hard rock drilling. This type of bit hammers on the rock face and reduces the rock to a fine power that is blown away to the hole entrance by the air that operates the repeating hammer as it circulates through the drill string and annulus. The prior art hammer drills utilize drilled, or cast, circular hole nozzles to blow away the fine rock powder.

A hammer drill including a plurality of nozzles of this invention that produce a plurality of fluid (or gas) jets, each of the non-circular jets has a velocity having a linear and an angular components, where the angular component is controlled by the angle of rotation of the flutes, the pressure of the fluid entering the inlet and the shape of the transition surfaces.

A power plant fuel “spud” injector assembly including a plurality of nozzles of this invention that produce a plurality of fluid (or fuel mixture) jets, each of the non-circular jets has a velocity having a linear and an angular components, where the angular component is controlled by the angle of rotation of the flutes, the pressure of the fluid entering the inlet and the shape of the transition surfaces.

The present invention relates to a nozzle apparatus including a first end including an inlet, a second end including an outlet, a volume extending from the inlet to the outlet, and a portion of a length of the volume including a twisted cross-section defining a twist angle, where the portion and the angle are sufficient to impart an angular velocity to a fluid passing through the apparatus.

The interior can further include at least one transition zone sufficient to impart a differential, cross-sectional pressure profile to the fluid passing through the apparatus, where the pressure profile includes at least one relative positive zone and at least one negative pressure zone that rotates at the angular velocity imparted by the twisted cross-sectional portion.

The portion extends over the entire length of the volume and the twisted profile can include a feature producing a spiral contour. The feature can comprise a baffle or blade extending from an inner wall of the volume into its interior along the length of the portion. The feature can also comprise a concave or convex region of the cross-sectional profile of the portion. The spiral contour can be continuous over the length of the portion of discontinuous over the length of the portion.

A cross-sectional profile of the portion can a geometrical shape that when rotated about a central axis produces a volume capable of imparting angular momentum to a fluid passing through the volume. The geometrical shape is selected from the group consisting of a polygon (triangle, quadrilateral—square, rectangle, etc.—, an oval, a closed contour including at least one concave or convex section, a contour including a least one inwardly extending finger, blade, protrusion, or indentation or any other closed geometrical contour that when rotated about a central axis and pulled down would generate a volume capable of imparting angular momentum to a fluid passing through the volume.

The present invention also relates to an apparatus comprising a body. The body includes a proximal end including an body inlet,a distal end including a plurality of nozzles. Each nozzle comprises a first end including a nozzle outlet, a second end including a nozzle inlet, a volume extending from the nozzle inlet to the nozzle outlet, and a portion of a length of the nozzle volume including a twisted cross-section defining a twist angle, where the length of the portion and the angle are sufficient to impart an angular velocity to a fluid passing through the apparatus. The apparatus also includes a cavity extending from proximal end to the nozzle inlets of the distal end and connecting the body inlet to the nozzle inlets.

The interior further includes at least one transition zone sufficient to impart a differential, cross-sectional pressure profile to the fluid passing through the apparatus, where the pressure profile includes at least one relative positive zone and at least one negative pressure zone that rotates at the angular velocity imparted by the twisted cross-sectional portion.

The portion can extend over the entire length of the volume and the twisted profile include a feature producing a spiral contour. The feature comprises a baffle or blade extending from an inner wall of the volume into its interior along the length of the portion. The feature comprises a concave or convex region of the cross-sectional profile of the portion. The spiral contour is continuous over the length of the portion. The spiral contour is discontinuous over the length of the portion. A cross-sectional profile of the portion comprises a geometrical shape that when rotated about a central axis produces a volume capable of imparting angular momentum to a fluid passing through the volume. The geometrical shape is selected from the group consisting of a polygon, an oval, a closed contour including at least one concave or convex section, a contour including a least one inwardly extending finger, blade, protrusion, or indentation.

The present invention relates to a drill bit comprising a plurality of nozzles including a first end including an inlet, a second end including an outlet, a volume extending from the inlet to the outlet, and a portion of a length of the volume including a twisted cross-section defining a twist angle, where the portion and the angle are sufficient to impart an angular velocity to a fluid passing through the apparatus to produce a plurality of fluid jets, each of the jets has a velocity having a linear and an angular components, where the angular component is controlled by the length of the portion, the twist angle, a pressure of the fluid entering the inlet and the shape of profile.

The present invention also relates to an internal combustion engine comprising a plurality of injector nozzles including a first end including an inlet, a second end including an outlet, a volume extending from the inlet to the outlet, and a portion of a length of the volume including a twisted cross-section defining a twist angle, where the portion and the angle are sufficient to impart an angular velocity to a fluid passing through the apparatus to produce a plurality of fluid jets, each of the jets has a velocity having a linear and an angular components, where the angular component is controlled by the length of the portion, the twist angle, a pressure of the fluid entering the inlet and the shape of profile.

The present invention relates to a method for producing a fluid flow having a linear and an angular velocities comprising the step of passing a fluid through a nozzle comprising a first end including an inlet, a second end including an outlet, a volume extending from the inlet to the outlet, and a portion of a length of the volume including a twisted cross-section defining a twist angle, where the portion and the angle are sufficient to impart an angular velocity to a fluid passing through the apparatus, at a pressure to produce a fluid flow having linear and angular momentum, the magnitude of which is controlled by the length of the portion, the twist angle, the pressure and the shape of profile.

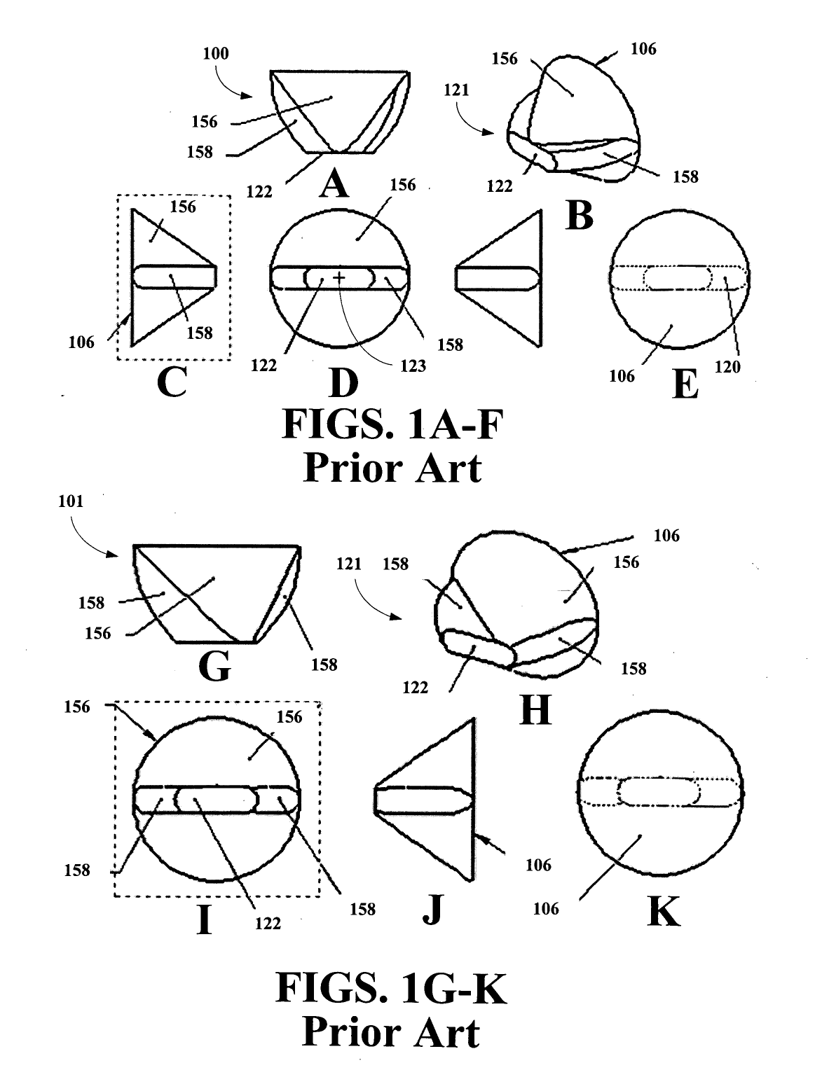

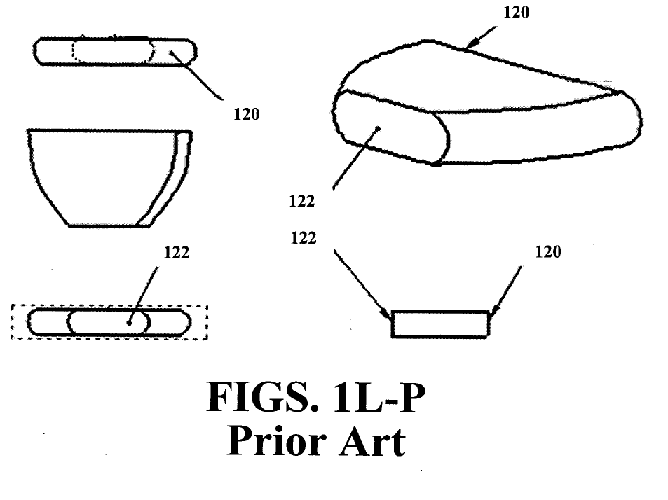

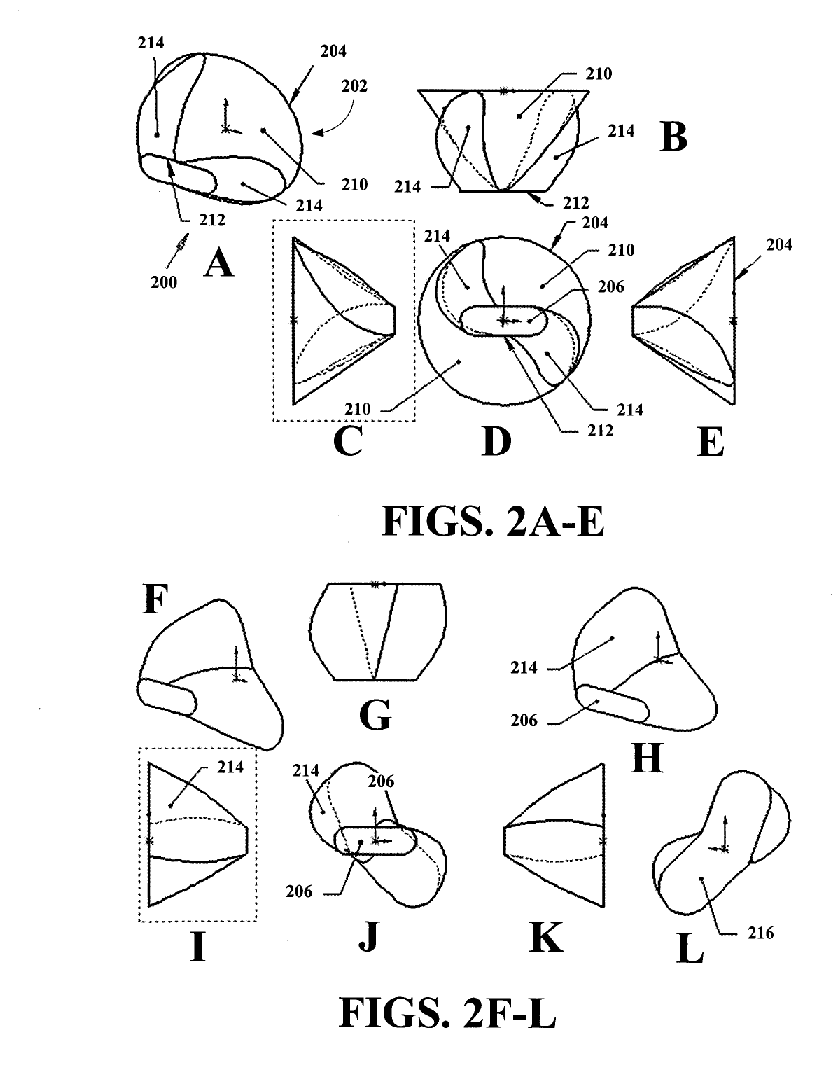

Referring now to FIG. 1A, a fluid passageway volume of a typical prior art nozzle 100, corresponding to FIG. 2 of U.S. Pat. No. 5,494,124 , is shown. In that prior art nozzle, the first transition surface 156 is formed by a right circular cone. The flute 121 has two constant radius segments that formed the second transitional surfaces 158. The end of the cone has a radius that matches (or is smaller than) that of the flute segments 158. The Boolean union of those two volumes defines the volume of fluid (or fluid passageway) defined by the nozzle 100. In FIG. 1A, the cone outlet and flute outlet areas are centered on a centerline 123 of the nozzle 100. Each flute transition surface 158 is formed by sweeping an area along a curve that remains in a diametrical plane centered on the nozzle centerline 123. That means that the flute transition surface 158 does not twist or spiral when viewed from either end of the nozzle 100. In other words, the flute region did not rotate or twist with a change it radial position along an axis from the inlet centroid to the outlet centroid in this case the nozzle centerline 123.

The prior art also disclosed that the circular conical outlet could be offset from its circular base inlet 106 and the nozzle centerline 123. An outset prior art fluid passageway defined by the nozzle 101 is illustrated in FIG. 1B, where the offset cone outlet has the same radius and center point as one rounded end of the flute outlet area 122. The Boolean union of the first transitional surface 156 and the flute transitional surface 158 are similar in shape, but produce different fluid output flows.

In both FIGS. 1A and 1B, the transitional surfaces 156 and 158 came from a single flute volume as shown in FIG. 1C. The prior art volume can be viewed as having a constant thickness and side surfaces that make a curvilinear convergence to the final outlet area 122, the curvilinear convergence is a portion of the surfaces that transition from the initial outlet area to the final outlet area. In addition, the cross-sectional profile did not rotate along an axis near the centerline 123 of the nozzle 101. The maximum dimension of the flute base 120 is typically chosen to match the inlet diameter of the fluid in the nozzle 101. The flute outlet area 122 typically contains within it, and tangent to it, the smaller outlet area of the first transitional surface. The first transitional surface is not restricted to arising from a straight cone. The first transition surface could be from nonlinear surfaces, as discussed herein. Typically, it is a transition from a circular base (inlet) to a smaller circular top (outlet). Of course, its base and top could have other (and different) shapes, like an ellipse.

Referring now to FIGS. 2A-E, a new nozzle configuration of this invention, generally 200, is introduced defining a new fluid passageway volume that produces a new fluid flow profile. In nozzle 200, flutes 202 are twisted, rotated or spiraled when viewed from either an inlet 204 or an outlet 206 of the nozzle 200. That is, a cross-sectional profile of the flutes 202 rotate radially about (perpendicular to) an axis near or a nozzle centerline 208 as one traverses from the inlet 204 to the outlet 206 along the axis. A first transition surface(s) 210 vary(ies) from the inlet 204 to a smaller top outlet 206 that fits within an outlet flute perimeter 212. Thus, second transition surfaces 214 also spiral or rotate as they converge to the outlet 206. Unlike the nozzles 100 and 101 of FIGS. 1A-C, where the flute ends maintained a constant radius during their convergence, the flutes 202 the nozzle 200 rotate in their convergence to the outlet 206 and their cross-sectional profile can vary or change as well as one traverses a distance from the inlet 204 to the outlet 206 along the axis. In the embodiment of FIG. 2, the flute end-radii decrease as one traverses the distance from the inlet 204 to the outlet 206 along the axis converging to the radius of the outlet 206. In another embodiment, the flute end-radii increases as one traverses the distance from the inlet 204 to the outlet 206 along the axis. By varying the flute end-radii, a designer is given the ability to control a relative portion of a total fluid volume in the nozzle 200 that is being forced to undergo rotational motion or to which an angular velocity component to the fluid flow is being imparted. Likewise, an amount of twist of the flute 202 can be controlled. As shown in FIG. 2D, both flutes 202 are seen to undergo a 45° rotation from the inlet 204 to the outlet 206, and they both twist or rotate in the same rotational direction (as defined by the “right hand rule”). Clearly, the flutes 202 could be designed to twist in different directions and/or have different angles of twist. For simplicity, FIGS. 2C-E show the Boolean union of a right circular cone with a volume generated by the flutes 202.

Referring now to FIGS. 2F-L, a two lobe flute volume is shown to include the flute inlet area 216 would be inscribed in the nozzle circular inlet diameter 204 of FIGS. 2A-E. As shown in FIG. 2F-L, an inlet flute curve radius as defined by the inlet 204 is larger than the corresponding radius of the outlet 206. The inlet area 216 spirals and reduces in size as it converges to the outlet 206. Its convergent surface 214 in some places will fall outside the first transitional surface 210, thereby creating the second transitional surfaces 214.

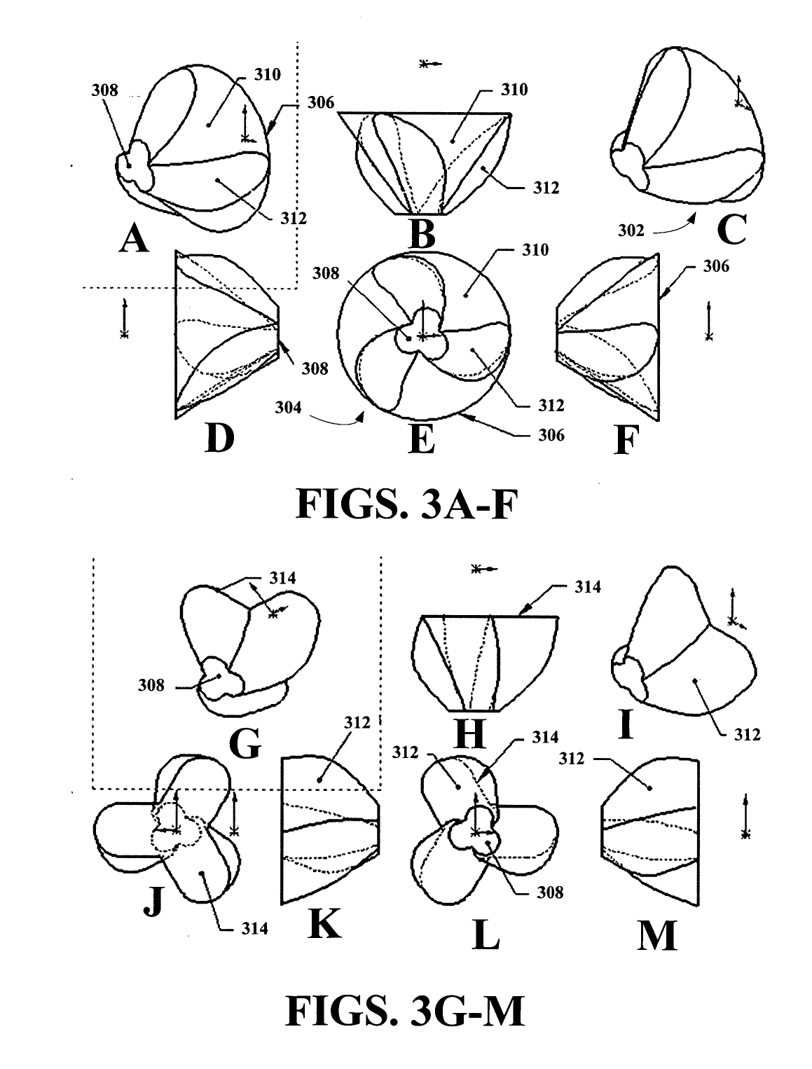

Referring now to FIGS. 3A-F, another embodiment of a nozzle of this invention, generally 300, is shown to include flutes 302 that form a tri-lobe or star outlet cross-sectional profile 304 and a circular inlet 306 that converges to an outlet 308. The profile 304 includes first transitional surfaces 310 and second transitional surfaces 312. The nozzle 300 illustrates a nozzle of this invention, where the three lobes have the same twist direction, the same twist angle, and flute radius, which decreases to the outlet 308. In this embodiment, there are three sets of cyclic symmetric pairs of surfaces 310 and 312. For simplicity, a nozzle volume is defined as an union of a centered right circular cone and a volume defined by the flutes 302 as shown in FIGS. 3G-M. An inlet area 314 is subscribed by a diameter of the inlet 306, a diameter of the outlet 308 (that also would typically contain the cone top), and convergent surfaces or transitional surfaces 312.

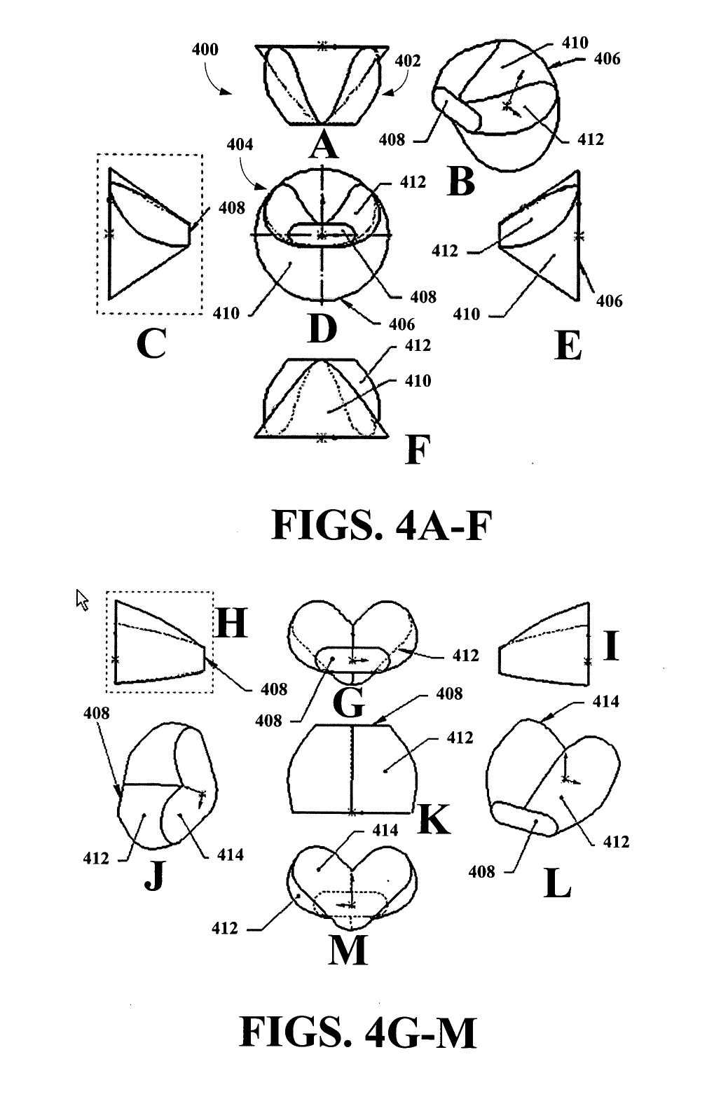

Referring now to FIGS. 4A-F, another embodiment of a nozzle of this invention, generally 400, is shown to include flutes 402 that twist in an opposite sense to form a rabbit ear type fluid flow passageway 404. The nozzle 400 includes an inlet 406, an outlet 408, a first transition surface 410 and convergent or second transition surfaces 412. The corresponding nozzle volume formed by a Boolean union of a right circular cone and a volume defined by the flutes 402 is shown in FIG. 4G-M and the nozzle 400 has an inlet area 414. The convergence surfaces 408, which in some regions lie outside the first transitional surface 408.

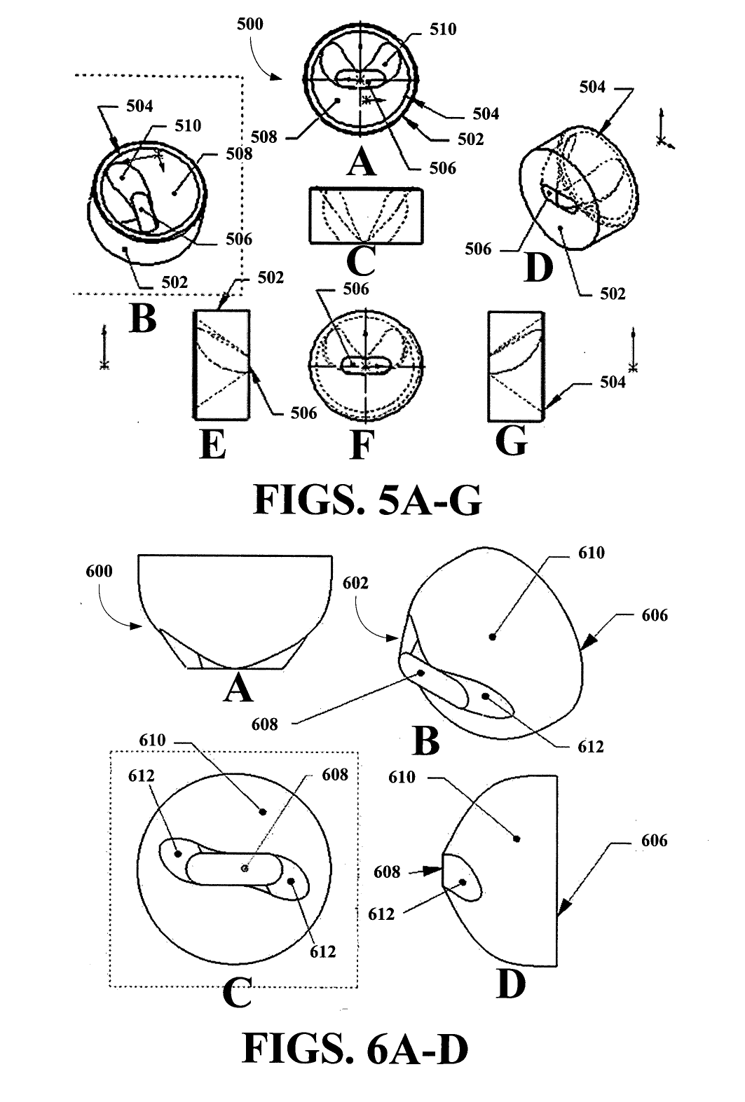

Referring now to FIGS. 5A-F, a solid nozzle, generally 500, is shown that produces the flute volume of FIGS. 4G-M. The solid nozzle 500 is formed by a Boolean subtraction of the fluid passageway of FIG. 4H and a cylindrical body 502. The nozzle body 502 has an inlet 504 having a desired diameter that converges to an outlet 506 having a desired cross-sectional area through internal first transitional surfaces 508 and second transitional surfaces 510. There are various well known methods for securing and/or orientating the solid nozzle 500 in a drill bit and are not described herein, but are described in U.S. Pat. Nos. , incorporated therein by reference.

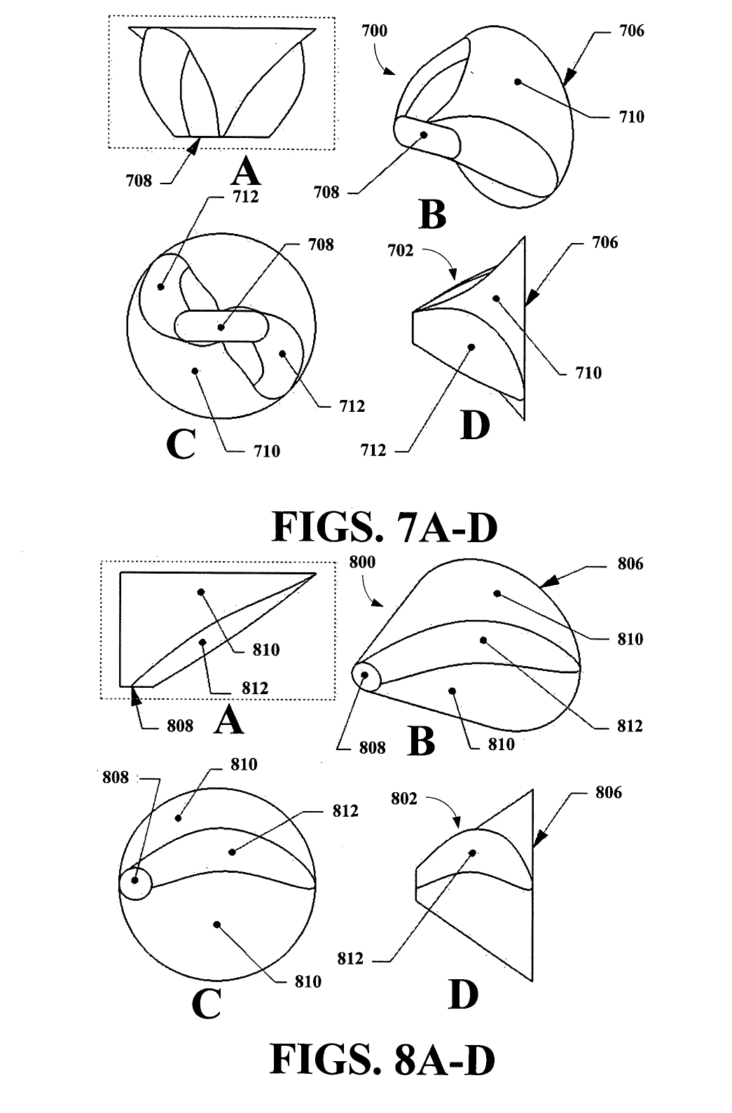

As mentioned earlier, the first transition surfaces can be formed in various ways. In addition to a straight cone, the transition surfaces can be concave or convex transition surfaces. Looking at FIGS. 6A-D, a nozzle, generally 600, is shown to include flutes 602, an inlet 606, an outlet 608 and concave transition surfaces 610 and 612. Looking at FIGS. 7A-D, a nozzle, generally 700, is shown to include to include flutes 702, an inlet 706, an outlet 708 and convex transition surfaces 710 and 712. The concave surface 606 of FIGS. 6A-D and the convex surface 706 of FIGS. 7A-D are both illustrated as being combined with the flute region of FIGS. 2F-L.

Referring now to FIGS. 8A-D, another embodiment of a nozzle of this invention, generally 800, is shown to include a single twisted flute 802, an inlet 806, an outlet 808 and transition surfaces 810 and 812. In this embodiment, the single twisted flute 802 transitions from the circular inlet 802 to a circular outlet 804, where the first transitional surface 808 forms an offset right circular cone. As shown in FIGS. 8A-D, the inlet 804 and outlet 806 lie in parallel planes, but a center of the outlet 806 does not coincide with the center of the inlet 804 relative to a centerline of the inlet 806. Although, in this embodiment, the offset inlet 806 and outlet 808 can be designed so that the inlet and outlet do not lie in parallel planes, i.e., the planes can form an angle therebetween greater than 0°. In certain embodiments, the plane angle ranges between >0° and 60°. In other embodiments, the plane angle ranges between 1° and 45°. In other embodiments, the plane angle ranges between 5° and 45°. In other embodiments, the plane angle ranges between 5° and 30°.

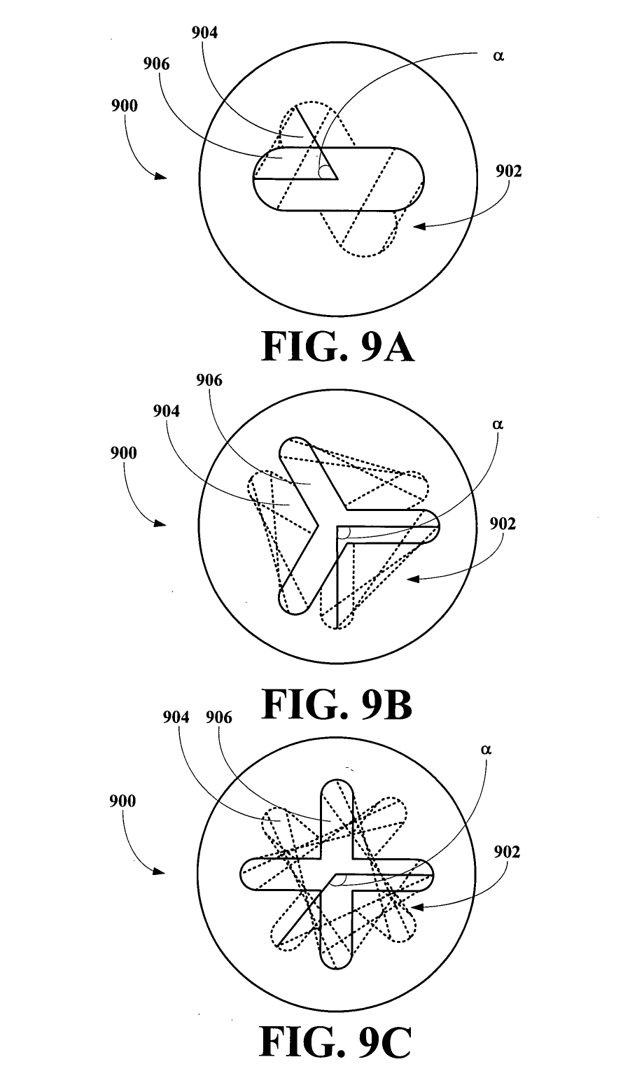

Referring now to FIGS. 9A-C, other embodiments of a nozzle of this invention, generally 900, are shown to include a flute(s) 902, an inlet 904, and an outlet 906. The inlet 904 and outlet 906 have the same or similar shape, but are rotated by an angle a. Looking at FIG. 9A, the angle of rotation or twist α is about 30°. Looking at FIG. 9B, the angle of rotation or twist a is about 90°. Looking at FIG. 9C, the angle of rotation or twist α is about 120°. Unlike, the embodiments of FIGS. 2-8, the embodiments of FIGS. 9A-C are not designed to produce profiles having negative and positive zone, but are designed merely to produce a fluid flow having both a linear and angular flow component.

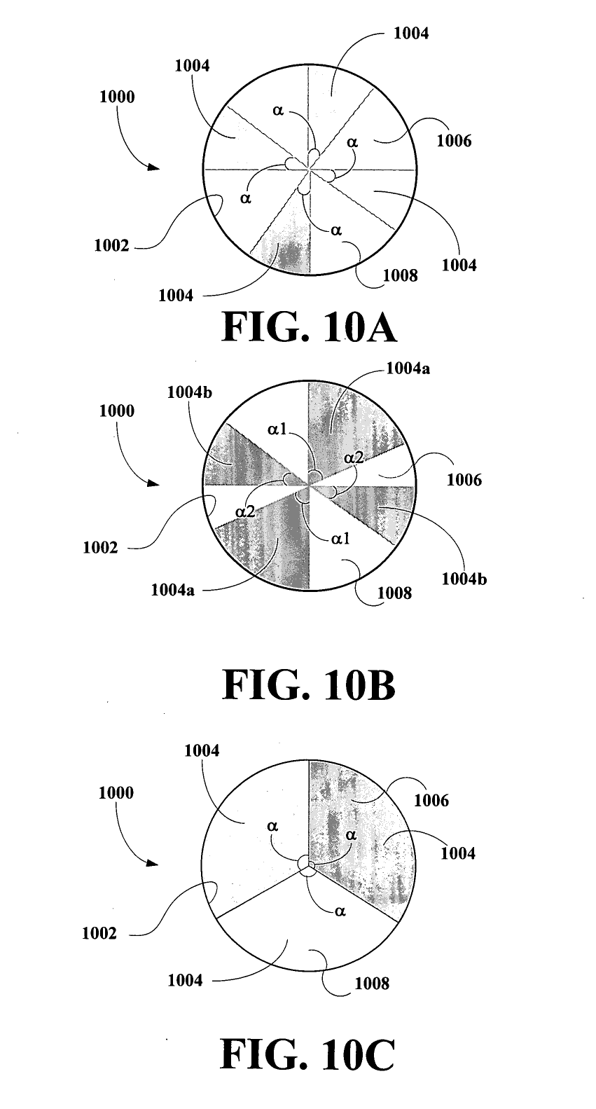

Referring now to FIGS. 10A-C, other embodiments of a nozzle of this invention, generally 1000, are shown to include a flute(s) 1002 having a baffles 1004, an inlet 1006, and an outlet 1008. The inlet 1006 and outlet 1008 have the same or similar shape, but the baffles 1004 impart a desired rotation by an angle α to the flow passing through the flute(s) 1002. Looking at FIG. 10A, the angle of rotation or twist α of the baffles 1004 is about 30°. Looking at FIG. 10B, the angle of rotation or twist α1 of the baffles 1004a is about 60° and the angle of rotation or twist α2 of the baffles 1004b is about 30°. Looking at FIG. 10C, the angle of rotation or twist a of the baffles 1004 is about 120°. Unlike, the embodiments of FIGS. 2-8, the embodiments of FIGS. 10A-C are not designed to produce profiles having negative and positive zone, but are designed merely to produce a fluid flow having both a linear and angular flow component.

Of course, nozzle can also be designed that include both rotated flutes and baffles. Moreover, if the flutes depth and profile can be altered by mechanical or electromechanical means, then the angular and linear components of the flow can be varied on the fly so that the fluid flow profiles at each nozzle or of the combined flow to adjust to changes in the formation.

We claim:

1. A nozzle apparatus comprising:
a first end including an inlet,
a second end including an outlet,
a volume extending from the inlet to the outlet, and
a portion of a length of the volume including a twisted cross-section defining a twist angle, where the portion and the angle are sufficient to impart an angular velocity to a fluid passing through the apparatus.

2. The apparatus of claim 1, wherein the interior further includes at least one transition zone sufficient to impart a differential, cross-sectional pressure profile to the fluid passing through the apparatus, where the pressure profile includes at least one relative positive zone and at least one negative pressure zone that rotates at the angular velocity imparted by the twisted cross-sectional portion.

3. The apparatus of claim 1, wherein the portion extends over the entire length of the volume.

4. The apparatus of claim 1, wherein the twisted profile include a feature producing a spiral contour.

5. The apparatus of claim 4, wherein the feature comprises a baffle or blade extending from an inner wall of the volume into its interior along the length of the portion.

6. The apparatus of claim 4, wherein the feature comprises a concave or convex region of the cross-sectional profile of the portion.

7. The apparatus of claim 4, wherein the spiral contour is continuous over the length of the portion.

8. The apparatus of claim 4, wherein the spiral contour is discontinuous over the length of the portion.

9. The apparatus of claim 1, wherein a cross-sectional profile of the portion comprises a geometrical shape that when rotated about a central axis produces a volume capable of imparting angular momentum to a fluid passing through the volume.

10. The apparatus of claim 9, wherein the geometrical shape is selected from the group consisting of a polygon, an oval, a closed contour including at least one concave or convex section, a contour including a least one inwardly extending finger, blade, protrusion, or indentation.

11. An apparatus comprising:
a body including:
a proximal end including an body inlet,
a distal end including a plurality of nozzles, each nozzle comprising:
a first end including a nozzle outlet,
a second end including a nozzle inlet,
a volume extending from the nozzle inlet to the nozzle outlet, and
a portion of a length of the nozzle volume including a twisted cross-section defining a twist angle, where the length of the portion and the angle are sufficient to impart an angular velocity to a fluid passing through the apparatus, and
a cavity extending from proximal end to the nozzle inlets of the distal end and connecting the body inlet to the nozzle inlets.

12. The apparatus of claim 11, wherein the interior further includes at least one transition zone sufficient to impart a differential, cross-sectional pressure profile to the fluid passing through the apparatus, where the pressure profile includes at least one relative positive zone and at least one negative pressure zone that rotates at the angular velocity imparted by the twisted cross-sectional portion.

13. The apparatus of claim 11, wherein the portion extends over the entire length of the volume.

14. The apparatus of claim 11, wherein the twisted profile include a feature producing a spiral contour.

15. The apparatus of claim 14, wherein the feature comprises a baffle or blade extending from an inner wall of the volume into its interior along the length of the portion.

16. The apparatus of claim 14, wherein the feature comprises a concave or convex region of the cross-sectional profile of the portion.

17. The apparatus of claim 14, wherein the spiral contour is continuous over the length of the portion.

18. The apparatus of claim 14, wherein the spiral contour is discontinuous over the length of the portion.

19. The apparatus of claim 11, wherein a cross-sectional profile of the portion comprises a geometrical shape that when rotated about a central axis produces a volume capable of imparting angular momentum to a fluid passing through the volume.

20. The apparatus of claim 19, wherein the geometrical shape is selected from the group consisting of a polygon, an oval, a closed contour including at least one concave or convex section, a contour including a least one inwardly extending finger, blade, protrusion, or indentation.

21. A drill bit comprising a plurality of nozzles including a first end including an inlet, a second end including an outlet, a volume extending from the inlet to the outlet, and a portion of a length of the volume including a twisted cross-section defining a twist angle, where the portion and the angle are sufficient to impart an angular velocity to a fluid passing through the apparatus to produce a plurality of fluid jets, each of the jets has a velocity having a linear and an angular components, where the angular component is controlled by the length of the portion, the twist angle, a pressure of the fluid entering the inlet and the shape of profile.

22. An internal combustion engine comprising a plurality of injector nozzles including a first end including an inlet, a second end including an outlet, a volume extending from the inlet to the outlet, and a portion of a length of the volume including a twisted cross-section defining a twist angle, where the portion and the angle are sufficient to impart an angular velocity to a fluid passing through the apparatus to produce a plurality of fluid jets, each of the jets has a velocity having a linear and an angular components, where the angular component is controlled by the length of the portion, the twist angle, a pressure of the fluid entering the inlet and the shape of profile.

23. A method for producing a fluid flow having a linear and an angular velocities comprising the steps:
passing a fluid through a nozzle comprising a first end including an inlet, a second end including an outlet, a volume extending from the inlet to the outlet, and a portion of a length of the volume including a twisted cross-section defining a twist angle, where the portion and the angle are sufficient to impart an angular velocity to a fluid passing through the apparatus, at a pressure to produce a fluid flow having linear and angular momentum, the magnitude of which is controlled by the length of the portion, the twist angle, the pressure and the shape of profile.
